(19) United States
(12) Patent Application Publication
(10) Pub. No.: US 2016/0292688 A1
(43) Pub. Date: Oct. 6, 2016

(54) ONLINE PAYMENT TRANSACTION SYSTEM

(71) Applicant: BARCLAYS BANK PLC, London Greater London (GB)

(72) Inventors: Loren BARTON, London (GB); John CONLON, London (GB)

(21) Appl. No.: 14/777,827

(22) PCT Filed: Mar. 19, 2014
(86) PCT No.: PCT/GB2014/050861

§ 371 Date: Sep. 17, 2015

(30) Foreign Application Priority Data
Mar. 19, 2013 (GB) 1304971.3

(51) Int. Cl. G06Q 20/40; G06Q 20/10; G06Q 20/36; G06Q 20/02

(52) U.S. Cl. CPC G06Q 20/4016; G06Q 20/02; G06Q 20/102; G06Q 20/367

(57) ABSTRACT

A payment system automatically determines a confidence measure for each payment transaction initiated between a consumer device and a merchant server, based on data associated with the registered consumer and device that is stored by the payment system, and dynamically determines a transaction processing cost for the transaction based on the confidence measure. The payment system can also dynamically determine a set of credential data elements to be requested from the consumer device.

### FIELD OF THE INVENTION

This invention relates to a method and system for processing online payment transactions using a payment service provider.

### BACKGROUND OF THE INVENTION

Conventional methods of online payment include an online checkout model, where a customer orders a ‘basket’ of goods or services on a merchant website, and selects a ‘checkout’ option to order and pay for the contents of the basket. Payment may be effected by entering details of a payment card, including card number, card holder name, card expiry data, CVC code and billing address. However, such payment cards are notoriously susceptible to fraudulent use.

Intermediary payment service providers, such as PayPal®, Google Checkout® and Amazon Payments®, are a way of preventing fraudulent access to payment card details during a conventional checkout process, whereby the customer subscribes or registers with the payment service provider. The customer's financial account and/or payment card details are provided through an initial one-time registration process and then securely stored as customer details of an issued intermediary payment account, along with registered credentials such as a username and password. Subsequently, the customer can select payment using the payment service provider if supported by the merchant website during the online checkout process, and effect payment for the order by simply authenticating the registered credentials with the payment service provider. In this way, account and card details are shielded from fraudsters during the online payment transaction.

Nevertheless, such conventional payment service systems are still susceptible to fraudulent use, for example by identity theft, and are therefore exposed to risk of chargebacks, which typically occur when customers dispute charges on their account or payment card statements. Handling of excessive chargebacks requires significant resource overheads to process the credit payment back to the merchant and is often at significant financial expense to the merchant.

What is desired is a payment system that reduces the risk of chargebacks for the merchants and hence provides a technically more efficient payment processing infrastructure, while maintaining efficiency and simplicity of the check-out process for the customer.

### STATEMENT OF THE INVENTION

Different aspects of the present invention are defined in the independent claims.

In an embodiment of the invention, a payment system processes electronic payment for a transaction initiated between a consumer device and a merchant server by: receiving a request token and transaction data relating to the transaction, wherein the request token includes user data relating to an identity of a consumer registered with the payment system; processing the request token to authenticate the user data and in response, generating a payment token based on the transaction data; transmitting the payment token to a financial institution associated with the merchant server; and transmitting a confirmation message to the merchant server indicating that electronic payment for the transaction is accepted. The payment system further performs the steps of retrieving, from a secure database, data elements associated with the registered consumer; determining a confidence measure based on the retrieved data elements; generating a subsequent credit payment token based on the determined confidence measure; and transmitting the subsequent credit payment token to the financial institution associated with the merchant server.

In another aspect, the present invention provides a method of authenticating a registered user of a payment system for electronic payment of a transaction initiated between a registered user's electronic device and a merchant server via the payment system, the method comprising the payment system dynamically determining a set of credential data elements to be requested from the consumer device based at least on data associated with the registered user stored by the payment system.

In yet another aspect, the present invention provides a method of electronic payment for a transaction initiated between a consumer device and a merchant server via a payment system, the consumer device associated with a consumer registered with the payment system, wherein the method comprises determining a confidence measure for each transaction based at least on data associated with the registered consumer stored by the payment system and dynamically determining a transaction processing cost for the transaction based on the confidence measure.

In other aspects, there is provided a system comprising means for carrying out the methods as described above. In another aspect, there is provided a computer program arranged to carry out the method when executed by suitable programmable devices

### BRIEF DESCRIPTION OF THE DRAWINGS

There now follows, by way of example only, a detailed description of embodiments of the present invention, with references to the figures identified below.

FIG. 1 is a schematic block diagram illustrating the main components of an overall online payment environment according to an embodiment of the invention.

FIG. 2 is a flow diagram illustrating the main processing steps performed by the payment system in an electronic online payment process for a transaction.

FIG. 3 is a schematic block diagram of the payment system of FIG. 1, illustrating in more detail the exemplary data units and flows of data between components of the payment system according to an embodiment of the invention.

FIG. 4, which comprises FIGS. 4a to 4c, is a schematic illustration of exemplary web pages served by the payment system to a consumer device according to the scaled authentication process of an alternative embodiment.

FIG. 5 is a diagram of an example of a computer system on which one or more of the functions of the embodiments may be implemented.

### DETAILED DESCRIPTION OF THE EMBODIMENTS

### Technical Architecture

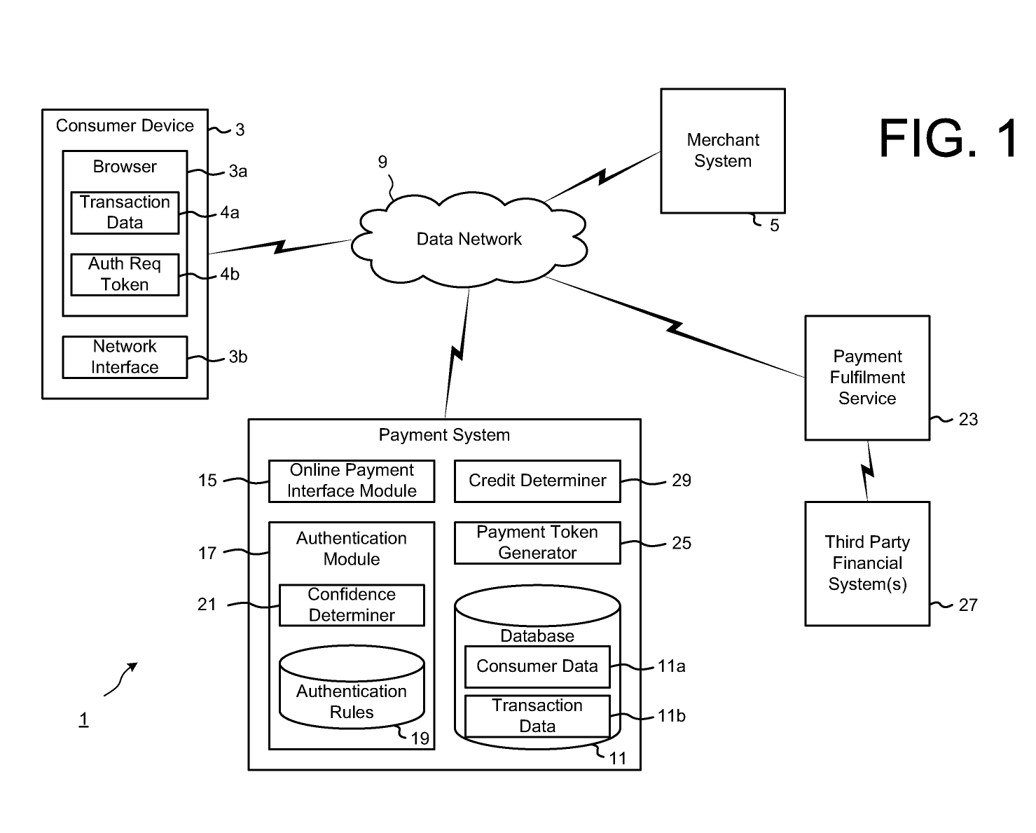

Referring to FIG. 1, an online payment environment 1 according to embodiments of the invention comprises a consumer device 3 associated with a consumer wishing to effect a payment transaction for purchase of a product or service provided by a merchant, via a payment system 7 associated with an intermediary payment service provider. The consumer device 3 is connected or connectable to a merchant system 5 associated with the merchant over a data network 9. The consumer device 3 and the merchant system 5 are also connected or connectable to the payment system 7 over the data network 9.

It will be appreciated that the consumer can be interchangeably referred to as a customer, user, end user or the like, the merchant can be interchangeably referred to as a retailer, vendor, business, broker, service provider or the like, and the intermediary payment service provider can be interchangeably referred to as a payment service provider, payment issuer or the like.

The consumer device 3 may be of a type that is known per se, such as a desktop computer, laptop computer, a tablet computer, a smartphone such as an iOS™, Blackberry™ or Android™ based smartphone, a ‘feature’ phone, a personal digital assistant (PDA), or any processor-powered device with suitable input and display means. The device 3 may be a terminal of the network 9.

The data network 9 may comprise a terrestrial cellular network such as a 2G, 3G or 4G network, a private or public wireless network such as a WiFi™-based network and/or a mobile satellite network or the Internet. It will be appreciated that a plurality of, and preferably a large number of consumer devices 3 and merchant systems 9 are operable concurrently within the system.

The consumer device 3 has a browser application 3a, or a dedicated application, for accessing and interacting with an online store hosted by the merchant system 5 connected to the network 9. The online store displays items that a consumer may select for purchase, and stores the selected item(s) selected by the consumer during a session in a ‘basket’ or other model representing a set of items selected for purchase, illustrated generally in FIG. 1 as transaction data 4a. The merchant system 7 may comprise multiple components (not shown), such as a web server for serving web pages to a consumer's browser 3a and a back-end server for storing data representing consumers and baskets, and interfacing with payment systems, such as the intermediary payment system 7. The consumer device 3 may be a client of the merchant system 5, although embodiments of the invention may not be limited to a client-server model.

The payment system 7 interacts with the consumer device 3 to authorize and process payments by interaction with an authenticated user of the consumer device 3. The payment system 7 has access to one or more database(s) 11 including consumer data 11a relating to subscribers or registered users of the payment service provider. The database 11 can also include transaction data 11b relating to specific payment sessions, for example. In the exemplary embodiment illustrated in FIG. 1, the browser application 3a of the consumer device 3 accesses and interacts with an online payment interface module 15 hosted by the merchant system 5 to provide credentials for authentication as one or more authentication request token(s) 4b. The online payment interface module 15 can serve one or more web page(s), or portion(s) of a web page such as inline frames or the like, to the consumer's browser 3a to prompt for a set of credentials for authentication.

The payment system 7 also includes an authentication module 17 that can determine the set of credentials to request from the consumer device 3 for authentication based on predefined authentication rules 19. As will be described in more detail below, the authentication module 17 includes a confidence determiner module 21 to determine a confidence measure for the consumer, based on the received credentials and the associated consumer data 11a for the registered consumer that is stored in the database 11.

The payment system 7 may be connected to, or may comprise a payment fulfillment service 23 of a type that is known per se. The payment fulfillment service 23 receives payment tokens from a generator module 25 in the payment system 7 and executes the requested payments between specified consumer and merchant accounts. It is appreciated that the consumer and merchant accounts can be maintained by the payment system 7 and/or conventional third party financial system(s) 25, such as a bank card issuer, a merchant acquirer, a financial institution, a business entity or the like. Preferably, although not necessarily, the payment system 7 is associated with a payment account issuer that maintains at least one designated financial account and/or stored value account for the consumer, thereby enabling secure and direct access to a greater set of consumer data 11a, such as historical account activity-related details 31c that can be directly updated by the payment system 7 as the consumer uses the account.

In this embodiment, the payment system 7 also includes a module 29 that determines an amount of credit (interchangeably referred to as a refund, rebate or cash back) to be paid back to the merchant account, based on a combination of the authentication rules 19 and/or the confidence measure for the consumer determined by the authentication module 17. As will be described in more detail below, the payment system 7 uses the rules-based authentication process to flexibly and efficiently determine an additional level of confidence for the transaction based on the amount and/or quality of information that is available from the secure database 11 of the payment system 7 to authenticate the consumer, thereby avoiding additional interaction with the consumer device for disclosure of further sensitive data during the check-out process. The overall transaction cost to the merchant can also be dynamically calculated based on the determined confidence measure on a per-transaction basis.

Online Payment Process

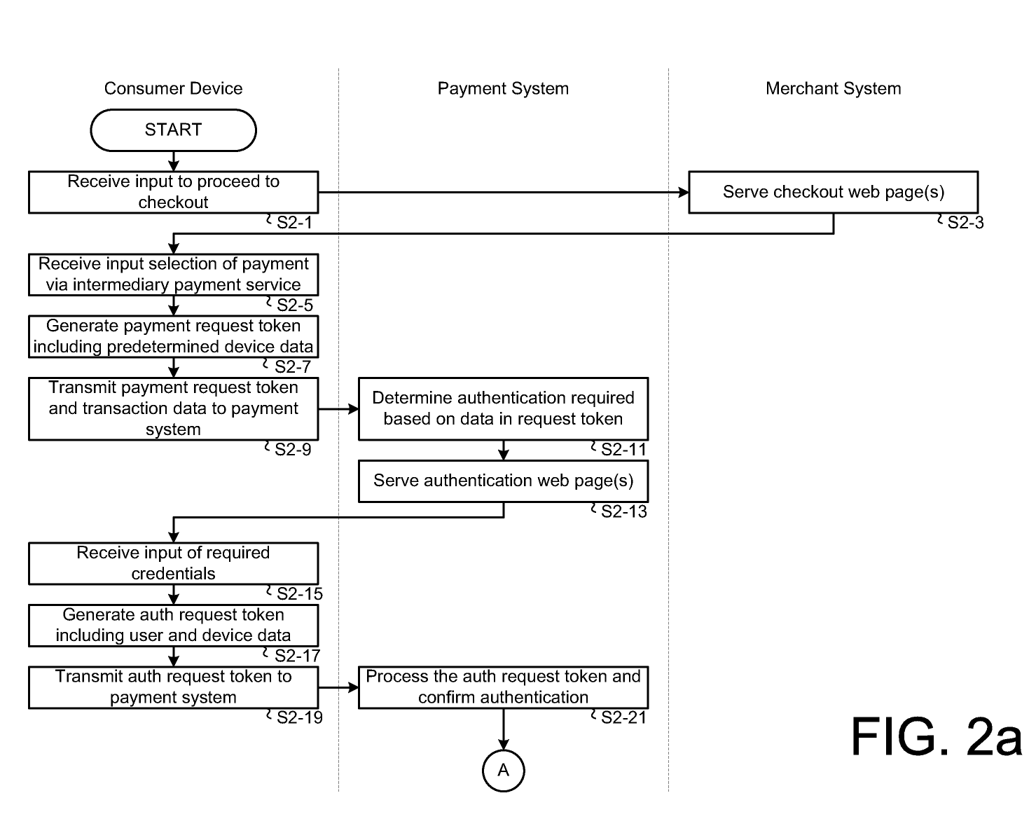

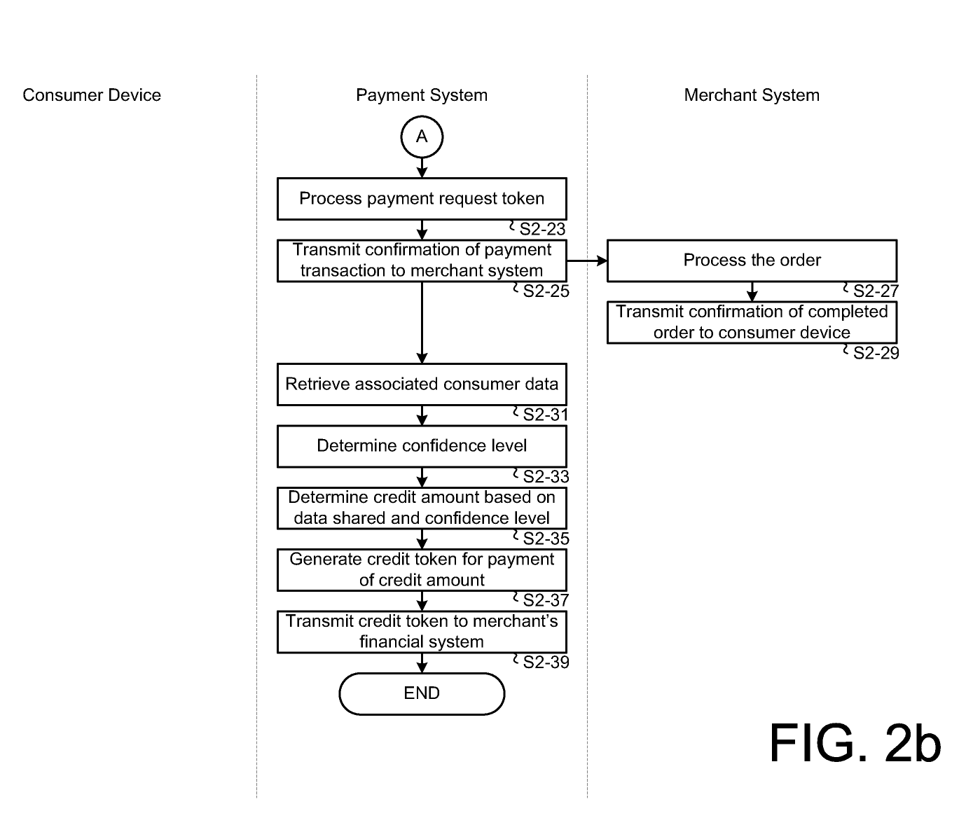

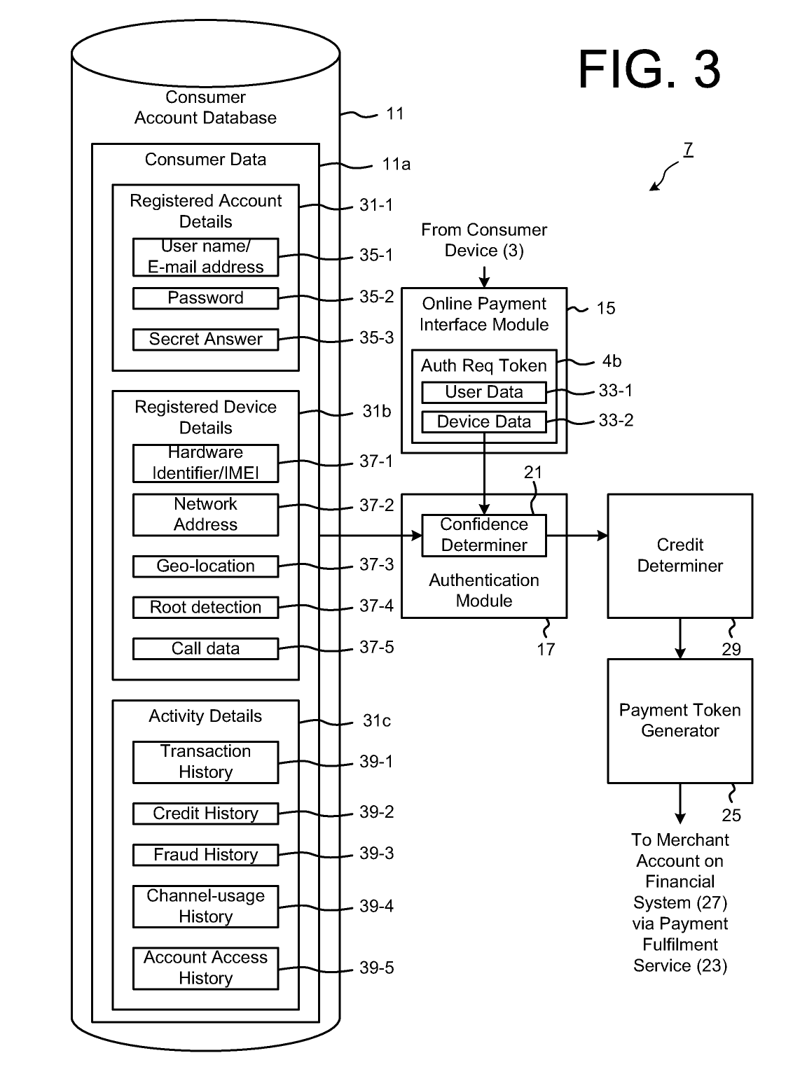

A brief description has been given above of the main components forming part of the online payment environment 1 of an exemplary embodiment. A more detailed description of the operation of these components will now be given with reference to the flow diagram of FIG. 2, for an example computer-implemented online order and payment process between the consumer device 3 and merchant system 5 in data communication with the payment system 7. Reference is also made to the schematic block diagram of FIG. 3 illustrating in more detail the exemplary data units and flows of data between components of the payment system 7 according to the described embodiments.

The process begins after the consumer has finished browsing an online store, for example on the merchant's website using the browser 3a or other application, and has selected one or more items which have been added to a ‘basket’ or any other model representing a selected for purchase. Accordingly, at step S2-1, the consumer device 3 receives input from the user wishing to complete the purchase by selecting a ‘checkout’ option on the website. At step S2-3, the merchant system 5 retrieves and serves the checkout web page to the consumer's browser 3a, the checkout web page including a plurality of user selectable options to instruct payment for the order by an associated payment instrument or service. At step S2-5, the consumer device 3 receives user input of a selected one of the payment options, which in this embodiment is payment via the payment system 7 associated with the intermediary payment service.

At step S2-7, the consumer device 3 generates a payment request token and transmits the token and transaction data to the payment system 7 at step S2-9, the transaction data including for example the total amount to be paid, information on specific items within the basket such as name and individual cost, and/or any specific conditions associated with the purchase. Preferably, although not necessarily, the transaction data can be protected from tampering by suitable cryptographic means, for example by encryption, a digital signature or a hash-based authentication code (HMAC). Alternatively, the merchant system 5 can make the payment request token and/or the transaction data available to the payment server 7.

Optionally, the payment request token can include data indicative of predetermined device-related information 31-2 as pre-registered with the payment system 7, such as a hardware identifier 37-1 and network address 37-2. For mobile handset consumer devices, the hardware identifier can be the IMEI (International Mobile Station Equipment Identity) number 37-1, the network address can be the IMSI (International Mobile Subscriber Identity) and the registered device details 31-2 can further include data elements such as: the mobile identification number (MIN), a physical geo-location 37-3 at the time of the request, root detection data 37-4 as typically used to identify whether the user of a mobile handset has access to the systems and software that are normally restricted to the operator or the handset manufacturers, historical call data 37-5, etc. In such an embodiment, the online payment interface module 15 of the payment system 7 can then determine a level of authentication required for the consumer device 3 based on the data elements provided in the payment request token, as illustrated at step S2-11 in FIG. 2. The online payment interface module 15 can determine a required level of authentication based on predefined authentication rules 19.

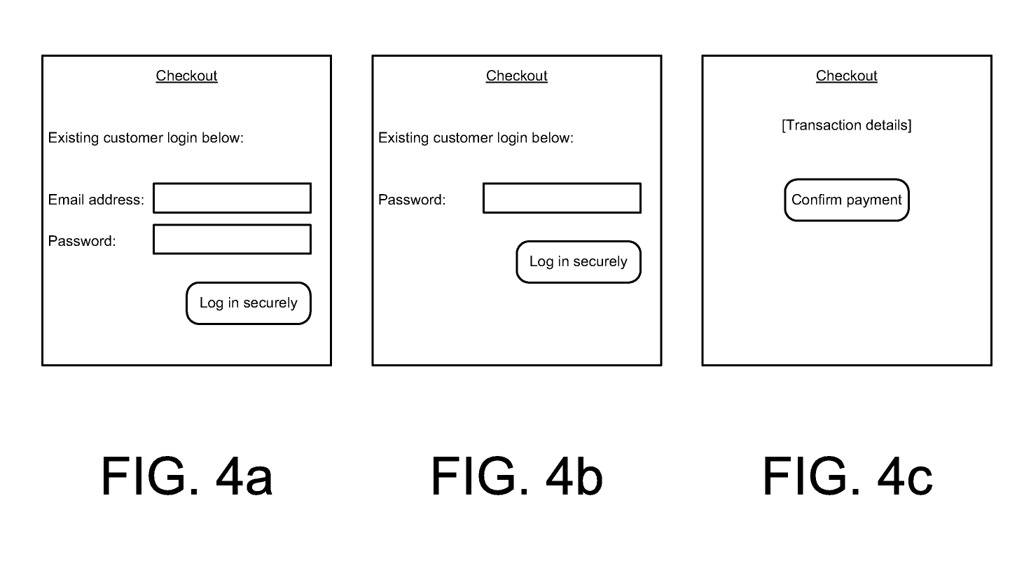

At step S2-13, the online payment interface module 15 serves the appropriate authentication web page to the consumer's browser 3a to prompt the user for their registered credentials 31-1. FIGS. 4a to 4c are schematic illustrations of exemplary checkout authentication web pages served by the payment system 7 to the consumer browser 3a according to the scaled authentication process of the alternative embodiment. As illustrated in FIG. 4a, when the provided device data and transaction details are determined to meet a low confidence threshold, then the user can be prompted to enter a greater number of credentials 31-1 to validate the payment, such as both the registered user name or e-mail address 35-1 and password 35-2. Alternatively or additionally, the user can be prompted to provide a pre-registered secret answer 35-3 to a personal question, the registered mobile identification number (MIN), details of the consumer's last transaction, details of the consumer's registered postal address or a previous registered address, etc.

On the other hand, when the provided device data and transaction details are determined to meet a high confidence threshold, then the user can be prompted to simply confirm payment for the transaction without requiring input of any credentials to validate the payment, as illustrated in FIG. 4c. Alternatively, a medium confidence threshold can be defined between the low and high confidence thresholds, whereby the user can be prompted to enter a lesser number of credentials to validate the payment, such as only the registered password 35-2, as illustrated in FIG. 4b.

For example, high confidence can be accredited where all of the conditions of a predefined rule are met, e.g. 1) a customer is fully registered with the system, whereby the customer has shared and registered predefined personal details such as name, address, date of birth, nationality, etc, and/or payment details such as credit card, expiry date & card CV2 code, so payments can be processed securely); and 2) the customer has shopped at same merchant using same channel, same device and same payment credentials as per a previous transaction identified in the customer's transaction history. Alternatively or additionally, the authentication rules 19 can define conditions based on any other form of customer related data element(s), such as the customer's historical spend behaviour and spend patterns, which can be used to determine if the customer's spend is below a predefined threshold value and consequently to associate a higher confidence for the transaction on the basis that this customer's transaction is not going to be fraudulent.

In contrast, a low confidence can be assigned if one or more of the following exemplary conditions are met: 1) the customer is a new customer, for example where the customer has not used the payment service before or is not recognised by a previous registered identifier; 2) the transaction value is high, for example compared to a predefined threshold value; and 3) the transaction is being processed abroad.

In this way, confidence can be determined for a transaction based on the multiple data points known about the customer, and the transaction can be measured against predefined risk associated with characteristics of such a transaction. It will be appreciated that the varying data elements/points, risks and rules can be defined in the system 1 as described above, and managed in an ongoing manner to ensure optimised outcome for customer, retailer and service provider.

As illustrated in the exemplary display screen of FIG. 4c, the authentication web page can be configured to display at least some of the transaction data to the user, when prompting the user to authorize the purchase of the items in the basket. The user may also be prompted to select from a list of registered modes of payment via the intermediary payment service, such as payment from a specific bank account registered with the payment system 7, and/or a electronic wallet or stored value account associated with the consumer device 3.

It will be appreciated that in a main embodiment, a default authentication web page can be used to prompt the user to provide both the registered user name or e-mail address 35-1 and password 35-2, for example as illustrated in FIG. 3a. Accordingly, at step S2-15, the consumer device 3 receives user input of the required credentials and generates an authentication request token 4b including the input user data 33-1, at step S2-17. In this embodiment, the authentication request token 4b also includes predetermined device data 33-2, for example as discussed above. It will be appreciated that the authentication web page can include code to request the predetermined data elements from the consumer device 3 for return to authentication module 17, as is known in the art. At step S2-19, the consumer device 3 transmits the authentication request token 4b to the payment system 7.

At step S2-21, the authentication module 17 of the payment system 7 processes the received authentication request token 4b to determine and confirm that the user data 33-1 provided in the token matches the registered account details 31-1 stored in the database 11. It will be appreciated that mechanisms can be provided to handle authentication request tokens that do not include registered user data, such as prompting the consumer to re-enter details or to securely retrieve forgotten or lost credentials. After the authentication module 17 verifies the provided credentials and authorizes the authentication request, the payment system 7 may proceed to process the payment request token at step S2-23, for example by effecting payment from the designated user account to the merchant's account via the payment fulfillment service 23 in a conventional manner. After the payment transaction is processed, the payment system 7 transmits a payment outcome token to the merchant system 5 at step S2-25.

At step S2-27, the merchant system 5 processes the order in accordance with the outcome indicated by the payment outcome token: if the payment is authorised, the transaction may be completed by processing the order for the items in the basket; if the payment is declined, the transaction is cancelled. Alternatively, the merchant system 5 may prompt the consumer device 3 to query the payment system 7 with the original payment request token to find out the outcome, for example if the payment outcome token does not arrive at the merchant system 5 within a predefined time.

As an optional additional step, the merchant system 5 may be required to present the payment outcome token to the payment system 7 in order to confirm that the transaction has been completed, and payment to the merchant may be suspended until this additional step is completed.

In this embodiment, after the payment system 7 has transmitted confirmation of the payment transaction to the merchant system 5 at step S2-25, the authentication module 17 proceeds to retrieve available additional consumer data 11a associated with the registered consumer identified by the user data 33-1 in the authentication request token 4b, from the secure database 11 at step S2-31. For example, the authentication module 17 can retrieve activity details 31-3 associated with the registered consumer, such as transaction history 39-1, credit history 39-2, fraud history 39-3, channel usage history 39-4, account access history 39-5, last known geo-location activity 37-3, etc. Based on the data shared by the consumer and the device 3 and any retrieved additional consumer data 11a associated with the consumer's registered account, the confidence determiner 21 of the authentication module 17 determines a confidence level for the consumer and the consumer device 3 at step S2-33. For example, the confidence determiner 21 can use predefined rules to calculate a score depending on the presence or absence of predetermined details in the consumer data 11a. Additionally, the score can depend on the accuracy and/or completeness of data provided by the consumer and/or consumer device 3 as compared to the corresponding registered details.

At step S2-35, the credit determiner 29 determines a credit amount to be refunded to the merchant based on the data shared by the consumer and consumer device 3 and the confidence level determined at step S2-33 above. The credit determiner 29 can determine a credit amount based on rules associating confidence levels and data shared with predefined amounts of cash back to be refunded to the merchant. For example, a credit amount of 0.0005% of the transaction fee can be defined where a predetermined number of consumer data 11a elements are available from the database 11 and/or match the data provided by the consumer device 3, and/or where the confidence score exceeds a first, relatively high, threshold value, for example as discussed above. A credit amount of 0.0025% of the transaction fee can be defined where only half of the predetermined number of consumer data 11a elements are available from the database 11 and/or match the data provided by the consumer device 3, and/or where the confidence score does not exceed the first threshold value, or exceeds a second threshold value that is lower than the first threshold. No credit amount can be given where just a single consumer data 11a element is available or provided by the consumer device 3 to authenticate the registered consumer, and where the confidence level is low and does not exceed the first or the second threshold values.

At step S2-37, the payment token generator 25 generates a credit token for payment of the determined credit amount to the merchant. The generated credit token is transmitted by the payment system 7 at step S2-39 to the merchant's financial system, for example via the payment fulfillment service 23, to effect payment of the calculated cash back to the merchant.

It will be appreciated that the above steps of calculating a confidence level and subsequently calculating a credit amount based on the confidence level can be combined as a single processing step, for example by retrieving and processing authentication rules 19 defining credit amounts or scale of credit amounts in relation to combinations of available data elements and respective confidence measures.

In this way, the payment system 7 can scale the authentication process for a consumer device 3 depending on a level of confidence associated with the registered consumer using the device that is determined based on consumer details available to the payment system. A simplified check-out and payment experience can therefore be provided for consumers that meet a high confidence threshold without compromising security from other consumers associated with a lower confidence. The present technical solution leverages supplemental data of multi-channel payment usage by the registered consumer that is securely gathered and stored by the payment service issuer and is therefore not readily accessible by the merchant, to efficiently and confidently determine a level of consumer presence from an issuer perspective rather than a merchant perspective. Consequently, risk of chargebacks can be reduced and further advantageously, merchants can benefit from scaled per-transaction fees in direct dependence upon the determined confidence or risk for each particular consumer.

Computer Systems

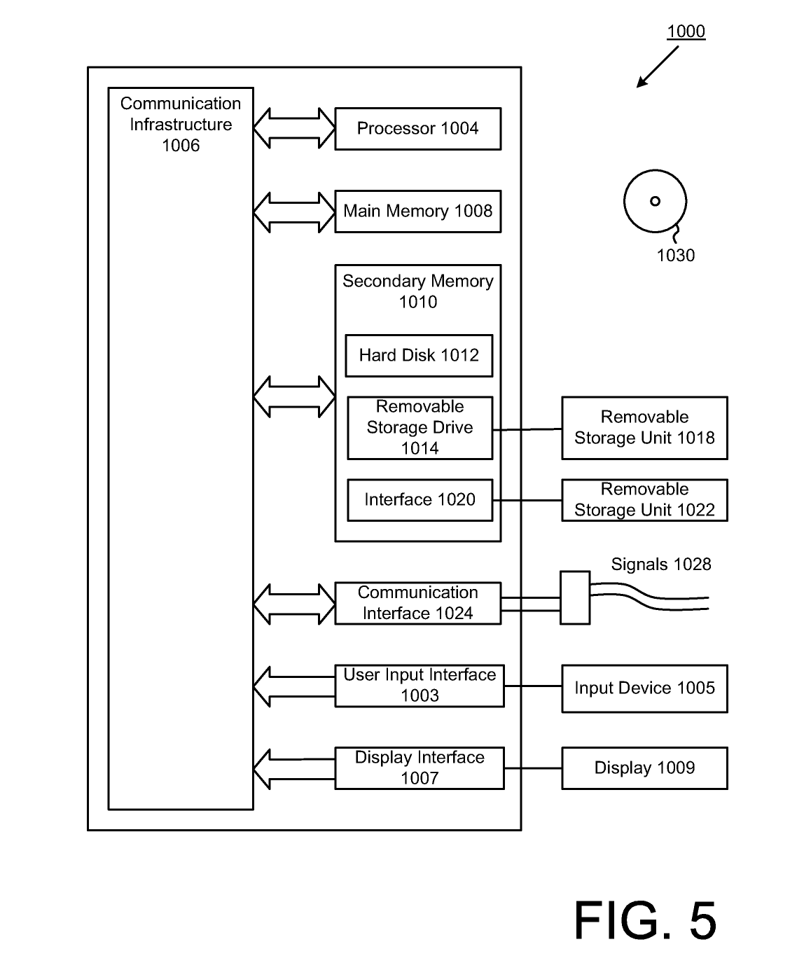

The entities described herein, such as the consumer device, the merchant system and the payment system, may be implemented by computer systems such as computer system 1000 as shown in FIG. 5. Embodiments of the present invention may be implemented as programmable code for execution by such computer systems 1000. After reading this description, it will become apparent to a person skilled in the art how to implement the invention using other computer systems and/or computer architectures.

Computer system 1000 includes one or more processors, such as processor 1004. Processor 1004 may be any type of processor, including but not limited to a special purpose or a general-purpose digital signal processor. Processor 1004 is connected to a communication infrastructure 1006 (for example, a bus or network). Various software implementations are described in terms of this exemplary computer system. After reading this description, it will become apparent to a person skilled in the art how to implement the invention using other computer systems and/or computer architectures.

Computer system 1000 also includes a user input interface 1003 connected to one or more input device(s) 1005 and a display interface 1007 connected to one or more display(s) 1009. Input devices 1005 may include, for example, a pointing device such as a mouse or touchpad, a keyboard, a touchscreen such as a resistive or capacitive touchscreen, etc. After reading this description, it will become apparent to a person skilled in the art how to implement the invention using other computer systems and/or computer architectures, for example using mobile electronic devices with integrated input and display components.

Computer system 1000 also includes a main memory 1008, preferably random access memory (RAM), and may also include a secondary memory 610. Secondary memory 1010 may include, for example, a hard disk drive 1012 and/or a removable storage drive 1014, representing a floppy disk drive, a magnetic tape drive, an optical disk drive, etc. Removable storage drive 1014 reads from and/or writes to a removable storage unit 1018 in a well-known manner. Removable storage unit 1018 represents a floppy disk, magnetic tape, optical disk, etc., which is read by and written to by removable storage drive 1014. As will be appreciated, removable storage unit 618 includes a computer usable storage medium having stored therein computer software and/or data.

In alternative implementations, secondary memory 1010 may include other similar means for allowing computer programs or other instructions to be loaded into computer system 1000. Such means may include, for example, a removable storage unit 1022 and an interface 1020. Examples of such means may include a program cartridge and cartridge interface (such as that previously found in video game devices), a removable memory chip (such as an EPROM, or PROM, or flash memory) and associated socket, and other removable storage units 1022 and interfaces 1020 which allow software and data to be transferred from removable storage unit 1022 to computer system 1000. Alternatively, the program may be executed and/or the data accessed from the removable storage unit 1022, using the processor 1004 of the computer system 1000.

Computer system 1000 may also include a communication interface 1024. Communication interface 1024 allows software and data to be transferred between computer system 1000 and external devices. Examples of communication interface 1024 may include a modem, a network interface (such as an Ethernet card), a communication port, a Personal Computer Memory Card International Association (PCMCIA) slot and card, etc. Software and data transferred via communication interface 1024 are in the form of signals 1028, which may be electronic, electromagnetic, optical, or other signals capable of being received by communication interface 1024. These signals 1028 are provided to communication interface 1024 via a communication path 1026. Communication path 1026 carries signals 1028 and may be implemented using wire or cable, fibre optics, a phone line, a wireless link, a cellular phone link, a radio frequency link, or any other suitable communication channel. For instance, communication path 1026 may be implemented using a combination of channels.

The terms “computer program medium” and “computer usable medium” are used generally to refer to media such as removable storage drive 1014, a hard disk installed in hard disk drive 1012, and signals 1028. These computer program products are means for providing software to computer system 1000. However, these terms may also include signals (such as electrical, optical or electromagnetic signals) that embody the computer program disclosed herein.

Computer programs (also called computer control logic) are stored in main memory 1008 and/or secondary memory 1010. Computer programs may also be received via communication interface 1024. Such computer programs, when executed, enable computer system 1000 to implement embodiments of the present invention as discussed herein. Accordingly, such computer programs represent controllers of computer system 1000. Where the embodiment is implemented using software, the software may be stored in a computer program product 1030 and loaded into computer system 1000 using removable storage drive 1014, hard disk drive 1012, or communication interface 1024, to provide some examples.

Alternative embodiments may be implemented as control logic in hardware, firmware, or software or any combination thereof.

### ALTERNATIVE EMBODIMENTS AND MODIFICATIONS

Alternative embodiments may be envisaged, which nevertheless fall within the scope of the following claims.

For example, in the embodiments described above, the intermediary payment system is provided as a separate component to the third party financial systems. It is appreciated that the payment system may alternatively be provided as a component of a financial institution's system, such as the customer's and/or merchant's financial institution, thereby removing the need for the payment tokens to be communicated to the destination financial institution via a payment scheme network.

1. A method of electronic payment for a transaction initiated between a consumer device and a merchant server via a payment system, the method comprising, at the payment system:
receiving a request token and transaction data relating to the transaction, wherein the request token includes user data relating to an identity of a consumer registered with the payment system;
processing the request token to authenticate the user data and in response, generating a payment token based on the transaction data;
transmitting the payment token to a financial institution associated with the merchant server; and
transmitting a confirmation message to the merchant server indicating that electronic payment for the transaction is accepted,
wherein the method further comprises, at the payment system:
retrieving, from a secure database, data elements associated with the registered consumer;
determining a confidence measure based on the retrieved data elements;
generating a subsequent credit payment token based on the determined confidence measure; and
transmitting the subsequent credit payment token to the financial institution associated with the merchant server.

2. The method of claim 1, wherein retrieving data elements from the secure database comprises querying the database to determine the presence of stored data for a predefined set of data elements, and wherein the confidence measure is determined based on the number of data elements with stored data.

3. The method of claim 1, further comprising comparing the user data received in the request token with corresponding retrieved data elements to determine a number of matching data elements, and wherein the confidence measure is determined based on the number of matching data elements.

4. The method of claim 1, wherein a value of the credit payment token is determined based on rules defining a scale of credit values associated with respective criteria.

5. The method of claim 4, wherein the criteria comprises a threshold value for the confidence measure.

6. The method of claim 4, wherein the criteria comprises availability of data elements from the database.

7. The method of claim 1, wherein the consumer registers details with the payment system prior to initiating a transaction.

8. The method of claim 1, further comprising the payment system transmitting a request for credentials including a determined set of required input data elements.

9. The method of claim 8, wherein the set of required input data elements is determined based on a confidence measure.

10. The method of claim 1, wherein the user data comprises one or more of the consumer's registered user name, email address, password, and secret word.

11. The method of claim 1, wherein the retrieved data elements include details indicated of aspects of account activity associated with a payment account of the registered consumer.

12. A method of authenticating a registered user of a payment system for electronic payment of a transaction initiated between a registered user's electronic device and a merchant server via the payment system, the method comprising the payment system dynamically determining a set of credential data elements to be requested from the consumer device based at least on data associated with the registered user stored by the payment system.

13. The method of claim 12, wherein said data associated with the registered user comprises historical account activity details.

14. A method of electronic payment for a transaction initiated between a consumer device and a merchant server via a payment system, the consumer device associated with a consumer registered with the payment system, wherein the method comprises determining a confidence measure for each transaction based at least on data associated with the registered consumer stored by the payment system and dynamically determining a transaction processing cost for the transaction based on the confidence measure.

15. A system comprising means for performing the method of claim 1.

16. A computer program comprising program code arranged to perform the method of claim 1.

17. A computer program product comprising the computer program of claim 16.
